(19) United States
(12) Patent Application Publication
(10) Pub. No.: US 2008/0320365 A1
(43) Pub. Date: Dec. 25, 2008

(54) PROVIDING AN INITIAL SYNDROME TO A CRC NEXT-STATE DECODER INDEPENDENTLY OF ITS SYNDROME FEEDBACK LOOP

(75) Inventor: Elizabeth Anne Richard, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/765,565

(22) Filed: Jun. 20, 2007

(51) Int. Cl. G06F 11/10

(52) U.S. Cl. 714/758; 714/785; 714/E11.032

(57) ABSTRACT

An initial syndrome for use by a next-state decoder in a cyclic redundancy check apparatus can be inserted independently of the syndrome feedback path and its associated clock. This eliminates a clock cycle penalty that would otherwise be imposed on an incoming data stream each time the initial syndrome value is inserted.

### FIELD OF THE INVENTION

The invention relates generally to cyclic redundancy check (CRC) processing and, more particularly, to syndrome generation in CRC processing.

### BACKGROUND OF THE INVENTION

Conventional CRC operation involves processing a data stream against a known CRC polynomial that yields a result that is nearly unique to that data stream. Modifications of bits in the data stream cause different CRC results. Consequently, if data is corrupted in delivery of the stream, the calculated CRC results will not match the expected CRC results. The width and values in the polynomial determine the strength (uniqueness) of the CRC. A next-state decoder (NSD) implements the calculation of the CRC polynomial against the incoming data. The CRC is widely applicable in many situations, for example, in endeavors that transmit, receive, store, retrieve, transfer, or otherwise communicate electronically represented digital information.

According to conventional CRC operation, and as shown in FIG. 1, a syndrome 11 contained in a feedback register (FB REG) 12 is fed back to the syndrome input 10 of the NSD 14. The NSD 14 also receives the current piece of incoming data 13. The resulting output 15 of the NSD 14 is registered into the feedback register 12, and thus becomes the next syndrome at 11 for the NSD 14 to use with the next piece of incoming data at 13. The initial state of the feedback register 12 (i.e., the initial syndrome value 11) is set to an appropriate value for the CRC polynomial that has been selected for use. A checksum generator 16 performs a predetermined operation on the final syndrome value 11 contained in the feedback register 12 after all of the incoming data 13 has been processed. The checksum generator 16 produces a CRC checksum value 17. The checksum value determined by the checksum generator 16 could be associated with (e.g., concatenated with, appended to, etc.) the data 13 for transmission, transfer, storage, etc., together with the data. An example would be a transmit packet having a checksum field associated with its data (payload) portion. The checksum value determined by the checksum generator 16 could be compared to a further checksum value that has been received, retrieved, etc., together with the data 13. An example would be a received packet whose checksum field contains the further checksum value and whose data (payload) portion contains the data 13. Comparison of the further checksum value to the checksum value determined by the checksum generator 16 provides a basis for evaluating the validity of the received data 13.

After the final syndrome for a given set of input data (e.g., the data payload of a packet) is passed to the checksum generator 16, the feedback register 12 can be reset to the aforementioned initial syndrome value (with which to begin CRC processing of the next set of input data) by activating an initialization control signal (INIT) at a control input 19 of the feedback register 12. However, the initial syndrome value is not present at the output 11 of feedback register 12, and thus does not become available to the NSD 14, until the next cycle of the clock signal 18. Therefore, a clock cycle delay is imposed at the beginning of each new set of input data. The input data stream can be adapted to accommodate this delay, but the clock cycle penalty on throughput must be absorbed.

It is therefore desirable to provide for syndrome initialization without the aforementioned clock cycle delay penalty on throughput.

### BRIEF DESCRIPTION OF THE DRAWINGS

FIG. 1 diagrammatically illustrates the structure and operation of a CRC apparatus according to the prior art.

FIG. 2 diagrammatically illustrates the structure and operation of a CRC apparatus according to exemplary embodiments of the invention.

### DETAILED DESCRIPTION

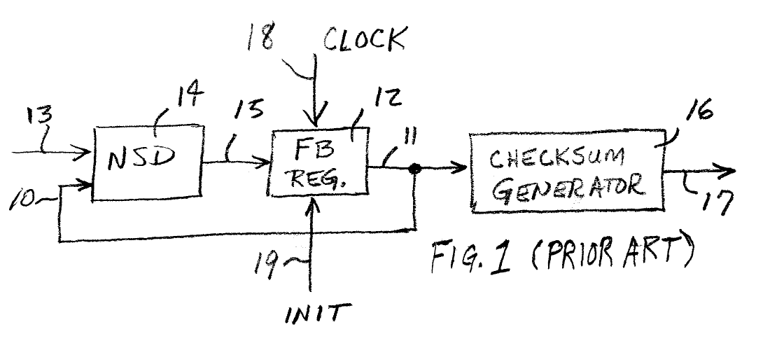

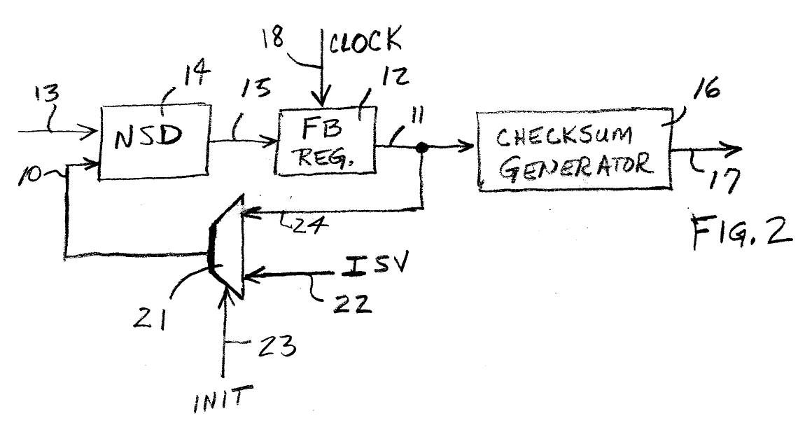

FIG. 2 diagrammatically illustrates the structure and operation of a CRC apparatus according to exemplary embodiments of the invention. The CRC apparatus of FIG. 2 includes structure that is similar to that of FIG. 1, but further includes a selector 21 inserted between the output of the feedback register 12 and the syndrome input 10 of the NSD 14. The selector 21 serves as an initializer for the NSD 14. The selector 21 has an input 24 that receives the syndrome 11 currently contained in the feedback register 12, and an input 22 that receives an initial syndrome value (ISV). The output of the selector 21 feeds the syndrome input 10 of the NSD 14. The initialization control signal INIT is applied to a control input 23 of the selector 21. The selector input 22 provides for the ISV a path to the syndrome input 10 that is separate from the syndrome feedback path, 15→12→11→24. In accordance with the signal INIT, these separate paths provided by the respective selector inputs 22 and 24 are selectively coupled to the syndrome input 10 by the output of the selector 21. In various embodiments, the selector 21 is implemented by a multiplexer or other suitably configured switch or switching circuit.

During normal operation, the INIT signal selects the syndrome 11 from the feedback register 12 to feed the syndrome input 10 of the NSD 14. When it is necessary to initialize (or re-initialize) the NSD 14 with the ISV, the INIT signal selects the ISV to feed the syndrome input 10. The selector 21 couples the ISV to the syndrome input 10 independently of the syndrome feedback path, 15→12→11→24, and independently of the clock 18. The ISV can therefore be applied to the syndrome input 10 immediately after the last syndrome 11 for a given set of input data (e.g., the data payload of a packet) is clocked into the feedback register 12, without awaiting the next clock cycle. Thus, the first syndrome produced at 15 by the NSD 14 for the next set of input data will be available to be clocked into the feedback register 12 upon the next clock cycle, thereby avoiding the aforementioned clock cycle penalty on throughput associated with the prior art apparatus of FIG. 1.

Although exemplary embodiments of the invention have been described above in detail, this does not limit the scope of the invention, which can be practiced in a variety of embodiments.

What is claimed is:

1. A cyclic redundancy check apparatus, comprising:
a next-state decoder having a data input, a syndrome input, and a syndrome output;
a syndrome feedback path coupled between said syndrome output and said syndrome input;
said next-state decoder configured to provide syndromes at said syndrome output based on respectively corresponding data at said data input and respectively corresponding syndromes at said syndrome input; and
an initial syndrome input for providing an initial syndrome to said next-state decoder, said initial syndrome input coupled to said syndrome input independently of said syndrome feedback path.

2. The apparatus of claim 1, including a selector that couples a selected one of said syndrome feedback path and said initial syndrome input to said syndrome input.

3. The apparatus of claim 2, including a control input coupled to said selector for providing an indication of which of said syndrome feedback path and said initial syndrome input is selected.

4. The apparatus of claim 2, wherein said selector includes first and second inputs respectively coupled to said syndrome feedback path and said initial syndrome input, and an output coupled to said syndrome input.

5. The apparatus of claim 1, including a signal path selectively coupled between said initial syndrome input and said syndrome input.

6. The apparatus of claim 1, wherein said syndrome feedback path includes a register for storing syndromes provided by said next-state decoder.

7. The apparatus of claim 6, wherein said register has an output coupled to said syndrome input.

8. A cyclic redundancy check apparatus, comprising:
a next-state decoder having a data input, a syndrome input, and a syndrome output;
a syndrome feedback path coupled between said syndrome output and said syndrome input, said syndrome feedback path having a control input for receiving a clock signal;
said next-state decoder configured to provide syndromes at said syndrome output based on respectively corresponding data at said data input and respectively corresponding syndromes at said syndrome input; and
an initializer coupled to said syndrome input and configured to provide an initial syndrome to said syndrome input independently of said clock signal.

9. The apparatus of claim 8, wherein said initializer includes an initial syndrome input and a switch coupled between said initial syndrome input and said syndrome input.

10. The apparatus of claim 9, wherein said switch is further coupled between said syndrome feedback path and said syndrome input.

11. The apparatus of claim 8, wherein said syndrome feedback path includes a register for storing syndromes provided by said next-state decoder.

12. The apparatus of claim 11, wherein said control input is a clock input of said register.

13. A cyclic redundancy check apparatus, comprising:
a next-state decoder having a data input, a syndrome input, and a syndrome output;
a syndrome feedback path coupled between said syndrome output and said syndrome input;
said next-state decoder configured to provide syndromes at said syndrome output based on respectively corresponding data at said data input and respectively corresponding syndromes at said syndrome input;
an initial syndrome input for providing an initial syndrome to said next-state decoder; and
a signal path, separate from said syndrome feedback path, coupled between said initial syndrome input and said syndrome input.

14. The apparatus of claim 13, including a selector that couples a selected one of said syndrome feedback path and said initial syndrome input to said syndrome input.

15. The apparatus of claim 14, including a control input coupled to said selector for providing an indication of which of said syndrome feedback path and said initial syndrome input is selected.

16. The apparatus of claim 14, wherein said selector includes first and second inputs respectively coupled to said syndrome feedback path and said initial syndrome input, and an output coupled to said syndrome input.

17. The apparatus of claim 13, wherein said syndrome feedback path includes a register for storing syndromes provided by said next-state decoder.

18. The apparatus of claim 17, wherein said register has an output coupled to said syndrome input.

19. A method of initializing a next-state decoder of a cyclic redundancy apparatus, comprising:
providing an initial syndrome for use by the next-state decoder; and
applying the initial syndrome to the next-state decoder independently of a syndrome feedback path of the next-state decoder.

20. The method of claim 19, including applying to the next-state decoder a selected one of the initial syndrome and a syndrome provided by the syndrome feedback path.
